(19) United States
(12) Patent Application Publication
(10) Pub. No.: US 2013/0313217 A1
(43) Pub. Date: Nov. 28, 2013

(54) RESIN CONTAINER AND RESIN CONTAINER MANUFACTURING METHOD

(71) Applicants: Sadaki Yamamoto, Chiba (JP); Motoaki Isokawa, Chiba (JP); Toshihiro Ito, Chiba (JP)

(72) Inventors: Sadaki Yamamoto, Chiba (JP); Motoaki Isokawa, Chiba (JP); Toshihiro Ito, Chiba (JP)

(73) Assignee: DU PONT-MITSUI POLYCHEMICALS CO., LTD., Minato-ku, Tokyo (JP)

(21) Appl. No.: 13/984,138

(22) PCT Filed: Feb. 22, 2012
(86) PCT No.: PCT/JP2012/001205

§ 371 Date: Aug. 7, 2013

(30) Foreign Application Priority Data
Feb. 23, 2011 (JP) 2011-037635

(51) Int. Cl. B65D 1/02; B29D 22/00

(52) U.S. Cl. CPC B65D 1/0215; B29D 22/003
USPC 215/12.1; 264/279

(57) ABSTRACT

A resin container (100) includes: a hollow molded body (10) which has a mouth-neck portion (20) and a tubular main body portion (12) with a bottom and is made of a first resin material such as polyolefin; and a resin sheathing body (30) which is made of a second resin material such as polyester and in which the main body portion (12) is buried in an unfixed manner. A frost-treated portion (122) subjected to a frost treatment is formed on at least a part of the main body portion (12).

### TECHNICAL FIELD

The present invention relates to a resin container and a resin container manufacturing method.

### BACKGROUND ART

Resin containers in which a resin sheathing body is molded by injecting a molten resin on the outside of a hollow molded body made of resin are proposed as a container which contains a liquid having fluidity such as skin lotion, chemicals, or beverages.

For example, Patent Document 1 (Japanese Unexamined Utility Model Registration Publication No. S52-159860) discloses a synthetic resin double container. This container is formed by injection molding of an outer layer made of a high-transparency material such as polyester or an acrylonitrile stylene co-polymer (AS resin) on an outer surface of an inner bottle portion made of polypropylene. Patent Document 1 discloses that since the outer layer is formed by the injection molding, the inner bottle portion and the outer layer favorably adhere to each other, and thus a clearance or the like is not generated between the inner bottle portion and the outer layer. Patent Documents 2 and 3 will be described later.

### RELATED DOCUMENTS

### Patent Documents

[Patent Document 1] Japanese Unexamined Utility Model Registration Publication No. S52-159860

[Patent Document 2] Japanese Unexamined Patent Publication No. H10-315358

[Patent Document 3] Japanese Unexamined Patent Publication No. 2002-037230

### DISCLOSURE OF THE INVENTION

Recently, the manufacturing of recyclable resin containers in consideration of environment has been desired. However, for a resin to which a chemical or the like adheres, a washing is needed before recycling. In addition, in some cases, a container in which many kinds of resins are mixed should be separated for each resin in order to be recycled and has poor recyclability. The container disclosed in Patent Document 1 has a problem in that the inner bottle portion to which a chemical or the like adheres and the outer layer cannot be separated from each other, and thus recyclability of it deteriorates.

According to the invention, there is provided a resin container including: a hollow molded body which has a mouth-neck portion and a tubular main body portion with a bottom and is made of a first resin material; and a resin sheathing body which is made of a second resin material and in which the main body portion is buried in an unfixed manner, in which a frost-treated portion subjected to a frost treatment is formed on at least a part of the main body portion.

According to the invention, there is provided a resin container manufacturing method including: holding a mouth-neck portion of a hollow molded body to a mold by engaging the mouth-neck portion with the mold, wherein the hollow molded body is made of a first resin material and has the mouth-neck portion and a tubular main body portion with a bottom, and in which a frost-treated portion subjected to a frost treatment is formed on at least a part of the main body portion; and an overmolding step of molding a resin sheathing body by applying an internal pressure greater than an ambient pressure to a hollow portion of the hollow molded body by charging a fluid into the hollow portion from the mouth-neck portion, and by charging a molten resin formed of a second resin material between the outside of the main body portion and the mold, in which in the overmolding step, the resin sheathing body and the main body portion are in an unfixed state due to thermal contraction of the hollow molded body.

According to the invention, the main body portion of the hollow molded body is buried in the resin sheathing body in an unfixed manner.

Accordingly, the resin sheathing body can be separated from the hollow molded body without any force applied, and thus the resin sheathing body after separation can be easily recycled. As described above, it is possible to provide a resin container which can be recycled after separation.

According to the invention, it is possible to provide a resin container which can be recycled after separation.

### BRIEF DESCRIPTION OF THE DRAWINGS

The above-described object and other objects, features, and advantages will be further obviously understood from the following preferred embodiments and accompanying drawings.

FIG. 1A is a cross-sectional view showing an entire resin container.

FIG. 1B is an enlarged view of the A part of FIG. 1A.

FIG. 2A is a cross-sectional view showing a process of accommodating a hollow molded body in a mold.

FIG. 2B is a cross-sectional view showing a state in which the hollow molded body is accommodated in the mold.

FIG. 3 is a cross-sectional view showing injecting a molten resin into the mold.

FIG. 4 is a cross-sectional view showing solidifying the injected molten resin.

FIG. 5 is a cross-sectional view showing removing the molded resin container from the mold.

FIG. 6 is a cross-sectional view showing a configuration of a resin container of a second embodiment.

FIG. 7 is a cross-sectional view showing a configuration of a resin container of a third embodiment.

### DESCRIPTION OF EMBODIMENTS

Hereinafter, embodiments of the invention will be described using the drawings. In all of the drawings, the same constituent elements will be denoted by the same reference numerals, and the description thereof will not be repeated.

### First Embodiment

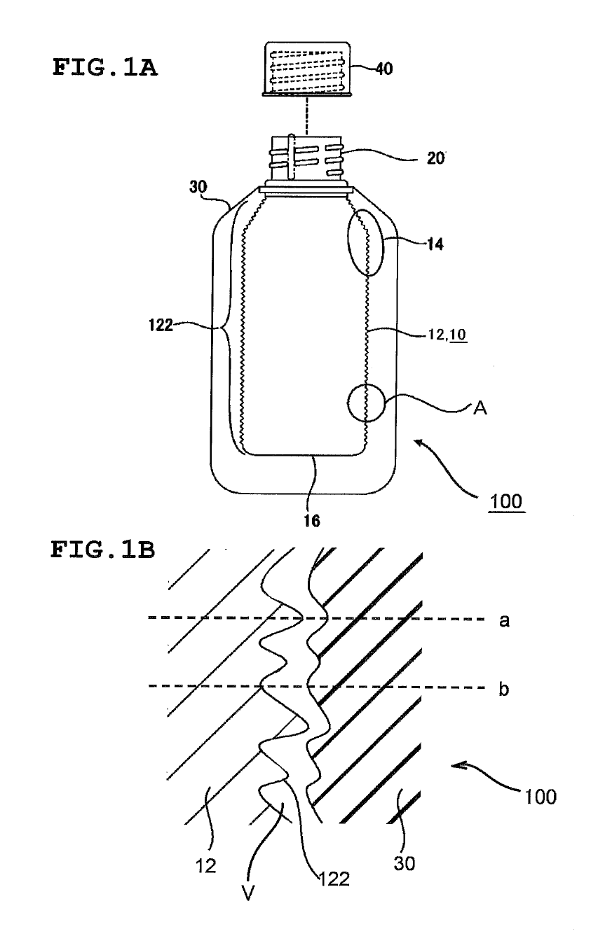

FIGS. 1A and 1B are views showing a configuration of a resin container 100 according to a first embodiment. FIG. 1A is a cross-sectional view showing the entire resin container 100. FIG. 1B is an enlarged cross-sectional view of the Apart of FIG. 1A. The resin container 100 is provided with a hollow molded body 10 and a resin sheathing body 30. The hollow molded body 10 has a mouth-neck portion 20 and a tubular main body portion 12 with a bottom, and is made of a first resin material. The resin sheathing body 30 is made of a second resin material. The main body portion 12 of the hollow molded body 10 is buried in the resin sheathing body 30 in an unfixed manner. A frost-treated portion 122 subjected to a frost treatment is formed on at least a part of the main body portion 12 of the hollow molded body 10. Hereinafter, detailed description will be given.

As shown in FIG. 1A, the resin container 100 is provided with the hollow molded body 10, the resin sheathing body 30, and a cap portion 40.

The hollow molded body 10 has the tubular main body portion 12 with a bottom and the mouth-neck portion 20. The main body portion 12 and the mouth-neck portion 20 of the hollow molded body 10 can contain contents. The contents are not particularly limited, and maybe a liquid, a gas, or a solid. Examples thereof include cosmetic products, chemicals, and beverages. That is, as the resin container 100 of this embodiment, a cosmetic container which is used to contain a cosmetic product in the hollow molded body 10 can be exemplified. Examples of the contained cosmetic product include liquid basic skin care products such as skin lotion and serum and liquid makeup products such as liquid foundation. Here, liquid cosmetic products mean that the products have fluidity, and include high-viscosity suspensions and paste-like materials in addition to low-viscosity liquids.

The mouth-neck portion 20 is formed into, for example, a cylindrical shape having a smaller diameter than the main body portion 12. The cap portion 40 is mounted on the mouth-neck portion 20 to seal the hollow molded body 10.

The hollow molded body 10 is made of a chemical-resistant material. Examples of the first resin material of the hollow molded body 10 include polyolefin-based resins such as polyethylene and polypropylene; polyesters such as polyethylene terephthalate (PET), amorphous polyethylene terephthalate (PETG), polytrimethylene terephthalate (PTT), polybutylene terephthalate (PBT), polycyclohexane dimethyl terephthalate (PCT), copolymers of PET and PCT (PCTG), copolymers of PCT and polycyclohexane dimethylene isophthalate (PCTA), and polyethylene naphthalate (PEN); acrylic resins; styrene-based resins such as a copolymer resin of styrene and acrylonitrile and a copolymer resin of styrene and methyl methacrylate; cycloolefin polymers; polycarbonates; polyamides; ionomer resins; polyacrylonitrile (PAN); ethylene vinyl alcohol copolymer (EVOH); and polyoxymethylene (POM).

The hollow molded body 10 may be made of the same first resin material as a whole, or have a configuration in which a different resin material is used for each part. That is, the first resin material may be a single kind of resin material, or conceptually include a plurality of kinds of resin materials.

Among the above examples, as the first resin material, polyolefin-based resins are preferable. Polyethylene and polypropylene are more preferable from the viewpoint of favorable chemical resistance. Polyesters and polyamides are preferable from the viewpoint of a relatively high melting temperature. The reason for this is that in a state in which the hollow molded body 10 is set in a mold, a high-temperature molten resin is overmolded on an outer surface thereof, thereby forming the resin sheathing body 30. By using the same material as the following resin sheathing body 30, a synergistic effect with the resin sheathing body 30 is obtained, and thus it is possible to increase high-class feeling, good appearance, and sensuousness of the resin container 100.

The frost-treated portion 122 subjected to a frost treatment is provided on a surface of the main body portion 12. The frost-treated portion 122 is a region subjected to a frost treatment in the main body portion 12. In this specification, “frost treatment” is a treatment of forming fine irregularities on a surface of a basis material such as a resin so as to scatter visible light rays. The frost-treated portion 122 may occupy the entire main body portion 12, or a part of the main body portion 12.

The surface roughness Ra of a surface of the frost-treated portion 122 is, for example, equal to or greater than 0.4 μm and equal to or smaller than 1.2 μm. The surface roughness Ra can be measured on the basis of JIS B 0601:2001. A ground glass-like appearance having high-class feeling without gloss can be formed by forming the frost-treated portion 122 on the main body portion 12. Specifically, as the frost treatment, for example, a mechanical frost treatment such as a blasting treatment or a sanding treatment on a part or the whole of the main body portion 12, or a chemical frost treatment using a treatment liquid such as acid can be used. A texturing is formed in an inner surface of the mold which is used in the blow molding of the main body portion 12, and this texturing surface may be transferred to the outer surface of the main body portion 12 to form the frost-treated portion 122. Otherwise, fine irregularities can be formed on the surface of the main body portion 12 by multilayer blow molding of a plurality of polyolefins having a rate of change of a melt index or a swelling ratio adjusted to a predetermined rate to give frost feeling to a whole surface of the main body portion 12 (see Patent Documents 2 and 3).

At this time, the main body portion 12 of the hollow molded body 10 is buried in the resin sheathing body 30 in an unfixed manner. Such a form can be obtained by overmolding the resin sheathing body 30 on the outside of the main body portion 12 of the hollow molded body 10, as will be described later.

In this specification, “unfixed” indicates a state in which when the resin sheathing body 30 is broken as necessary to expose the main body portion 12 of the hollow molded body 10, separation by hand is possible without using specialized equipment. It also includes a state in which even when the hollow molded body 10 is partially fixed to the resin sheathing body 30, these can be substantially easily separated from each other as a whole. In the above-described state in which the hollow molded body 10 is exposed, the hollow molded body 10 is preferably detached due to the weight of the hollow molded body 10, or removed without applying a force.

In this specification, “buried” indicates a state in which the whole main body portion 12 in the hollow molded body 10 including shoulder portions 14 is guarded by the resin sheathing body 30. However, the mouth-neck portion 20 or an opening portion (not shown) which is smaller than the main body portion 12 may be exposed to such an extent that the hollow molded body 10 does not fall.

The resin sheathing body 30 is made of the second resin material. The second resin material may be the same as, or different from the first resin material. A material which is excellent in chemical resistance is preferably selected as the first resin material of the hollow molded body 10, and a different kind of material which is excellent in physical strength such as abrasion resistance and the like is preferably selected as the second resin material of the resin sheathing body 30.

The second resin material has visible light transparency, shape stability, an excellent physical strength, and the like, and is preferably recyclable material. Examples of the second resin material include polyolefin-based resins such as polypropylene; ionomer resins; acrylic resins; polyester-based resins; styrene-based resins such as a styrene-acrylonitrile copolymer resin, a styrene-methyl methacrylate copolymer resin, and an acrylonitrile-butadiene-styrene copolymer resin (ABS); polycarbonates; polyurethanes; and polyvinyl chloride resins. Ionomer resins and polyester resins can be preferably used, and polyester resins can be more preferably used.

Specific preferred examples of the polyester-based resins include polyethylene terephthalate (PET), amorphous polyethylene terephthalate (PETG), polycyclohexane dimethyl terephthalate (PCT), copolymers of PET and PCT (PCTG), and copolymers of PCT and polycyclohexane dimethylene isophthalate (PCTA). When the resin sheathing body 30 is made of a material having visible light transparency, the frost-treated portion 122 of the hollow molded body 10 can be visually confirmed through the resin sheathing body 30. Accordingly, it is possible to give higher-class feeling. In addition, when the resin sheathing body 30 is made of a recyclable material, only the resin sheathing body 30 which is not brought into contact with a chemical or the like can be separated and recycled.

As shown in FIG. 1B, the resin container 100 has a gap V between the surface of the main body portion 12 (frost-treated portion 122) subjected to a frost treatment and the resin sheathing body 30. Accordingly, the resin sheathing body 30 is not fixed to the hollow molded body 10 at least in the frost-treated portion 122. The “gap” mentioned here may have at least a part of the space between the surface of the main body portion 12 subjected to a frost treatment and the resin sheathing body 30. The gap V may be present between the whole outer surface of the main body portion 12 of the hollow molded body 10 and the resin sheathing body 30, or present in a part of the space between the outer surface of the main body portion 12 of the hollow molded body 10 and the resin sheathing body 30.

Both the surfaces of the hollow molded body 10 and the resin sheathing body 30, which are opposed to each other with the gap V interposed therebetween, have irregularities respectively, and the irregularities is formed in mutually corresponding form. Specifically, the surface of the frost-treated portion 122 and the inner surface of the resin sheathing body 30 which is opposed thereto have irregularities respectively, and the irregularities is formed in mutually corresponding form. Here, “mutually corresponding form” indicates a state in which a convex portion (or a concave portion) is formed on one side at a position opposed to a concave portion (or a convex portion) on the other side. The positions and depths of the apex portions of the irregularities on the both sides may be the same as, or different from each other.

For example, a convex portion formed on the surface of the main body portion 12 of the hollow molded body 10 is formed at an opposed position a in FIG. 1B. A concave portion which is shallower than the height of the convex portion formed on the main body portion 12 of the hollow molded body 10 is formed at a corresponding position on the inner surface of the resin sheathing body 30. In addition, a concave portion formed on the surface of the main body portion 12 of the hollow molded body 10 is formed at an opposed position b in FIG. 1B. A convex portion which is lower than the depth of the concave portion formed on the main body portion 12 of the hollow molded body 10 is formed at a corresponding position on the inner surface of the resin sheathing body 30.

In this manner, irregularities formed on the inner surface of the resin sheathing body 30 are smaller than irregularities formed on the surface of the frost-treated portion 122. The small irregularities indicate that the average of depths of the interior portions of the concave portions and the average of heights of the apex portions of the convex portions are small. When both the surfaces of the hollow molded body 10 and the resin sheathing body 30, which are opposed to each other, have irregularities corresponding to each other, respectively, the hollow molded body 10 and the resin sheathing body 30 are in an unfixed state, but relative positions thereof do not deviate from each other. When the irregularities on both the surfaces have the same size, there is a concern that the irregularities may fit together and be airtightly fixed to each other. Since the irregularities have different sizes, the gap V is securely interposed at the interface between the hollow molded body 10 and the resin sheathing body 30, and thus the unfixed state between the hollow molded body 10 and the resin sheathing body 30 can be maintained.

Another effect of the formation of irregularities formed in mutually corresponding form on both the surfaces of the hollow molded body 10 and the resin sheathing body 30, which are opposed to each other with the gap V interposed therebetween, is that light scattering occurring by the frost processing of the surface of the hollow molded body 10 can be clearly visually confirmed from the outside of the resin sheathing body. Therefore, the foggy glass-like hollow molded body having high-class feeling can be confirmed from the outside of the resin container, and design and aesthetic appearance can be enhanced. Due to different sizes of the irregularities formed on the hollow molded body 10 and the resin sheathing body 30, the gap V is securely interposed at the interface between the hollow molded body 10 and the resin sheathing body 30, and thus visible light rays are scattered well. Therefore, the foggy glass-like design and aesthetic appearance can be realized in good yield.

On the other hand, in the case of a resin container in which the hollow molded body 10 and the resin sheathing body 30 are strongly integrated with each other with no gap therebetween, light scattering does not easily occur at the interface between the hollow molded body 10 and the resin sheathing body 30. Therefore, since the frost processing of the surface of the hollow molded body cannot be clearly visually confirmed from the outside of the resin container, it is more difficult to clearly give the design and aesthetic appearance based on the frost processing than the above-described embodiments.

The shape of the hollow molded body 10 is not particularly limited. In this embodiment, a bottle shape having the shoulder portions 14, the diameter of which is increased from the mouth-neck portion 20 to the main body portion 12, is exemplified. The shoulder portion 14 of this embodiment is not perpendicular to, but inclined with respect to the central axis direction of the mouth-neck portion 20. The mouth-neck portion 20 and the shoulder portion 14, and the shoulder portion 14 and the main body portion 12 are smoothly connected to each other, respectively. Accordingly, the hollow molded body 10 of this embodiment has a bottle shape with sloping shoulders. In the resin container 100, the frost-treated portion 122 is formed on at least the surface of the shoulder portion 14. Here, for recycling of the resin container 100, the resin sheathing body 30 is cut vertically to be divided into two parts along the axial center of the mouth-neck portion 20. When the hollow molded body 10 is removed from the resin sheathing body 30 divided into two parts, the mouth-neck portion 20 is gripped by hand to raise the main body portion 12 from the resin sheathing body 30, whereby the hollow molded body 10 is detached. At the time when the hollow molded body 10 is raised and separated with the mouth-neck portion 20 serving as a point where a force is applied, a bottom portion 16 becomes a point of support, and the shoulder portion 14 which is a bending point of the resin container 100 becomes a point of action. By subjecting the shoulder portion 14 serving as a point of action to a frost treatment, the resin sheathing body 30 can be separated from the hollow molded body 10 without any force applied.

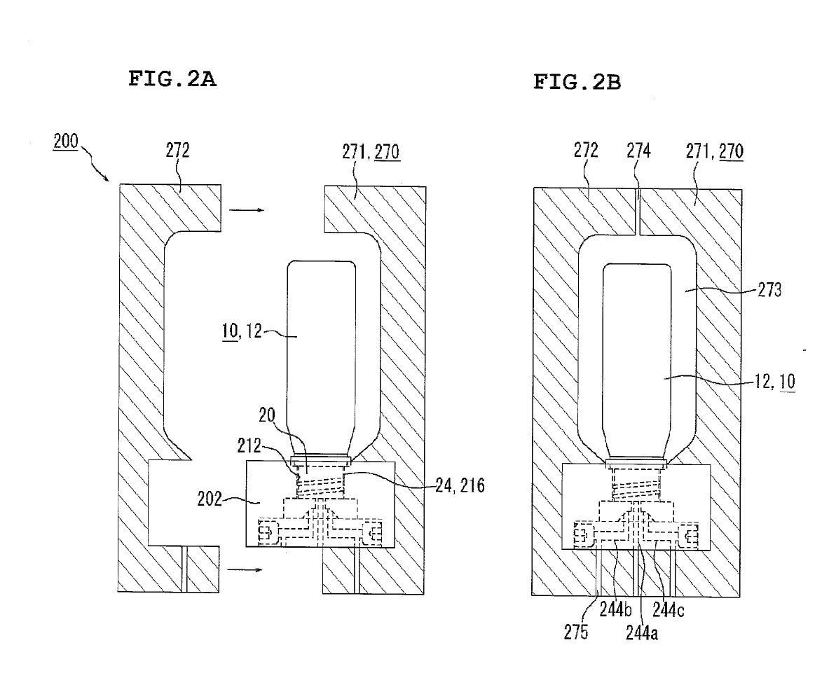

Next, a resin container manufacturing method according to the first embodiment will be described using FIGS. 2A to 5. FIGS. 2A to 5 are cross-sectional views showing the resin container manufacturing method according to the first embodiment.

This manufacturing method (the present method) includes a holding process and an overmolding process.

In the holding process, the mouth-neck portion 20 of the hollow molded body 10 made of the first resin material is engaged for holding in a mold 270. As described above, the hollow molded body 10 has the mouth-neck portion 20 and the tubular main body portion 12 with a bottom, and the frost-treated portion 122 subjected to a frost treatment is formed on at least a part of the main body portion 12.

Next, in the overmolding process, a fluid is charged into the hollow portion of the hollow molded body 10 from the mouth-neck portion 20 to apply an internal pressure greater than an ambient pressure. In this state, a molten resin 276 of the second resin material is charged between the outside of the main body portion 12 and the mold 270 to mold the resin sheathing body 30. In this overmolding process, the resin sheathing body 30 and the main body portion 12 are in an unfixed state due to the thermal contraction of the hollow molded body 10. Hereinafter, detailed description will be given.

First, the hollow molded body 10 which has the tubular main body portion 12 with a bottom and the mouth-neck portion 20 and is made of the first resin material such as polyolefin is prepared. The frost-treated portion 122 subjected to a frost treatment in advance is formed on the surface of the main body portion 12 of the hollow molded body 10.

As shown in FIG. 2A, in a resin molding device 200, the mouth-neck portion 20 of the hollow molded body 10 is allowed to head downward to engage the mouth-neck portion 20 of the hollow molded body 10 with a mouth part mold 202. Accordingly, the hollow molded body 10 is held in the mold 270. Here, the mouth part mold 202 is provided with flow paths 244a, 244b, 244c and pipe lines 275 for flowing of a fluid.

Next, as shown in FIG. 2B, split molds 271 and 272 are allowed to be opposed to each other and combined with each other. In this manner, a cavity 273 is formed in the mold 270 and the main body portion 12 of the hollow molded body 10 is accommodated.

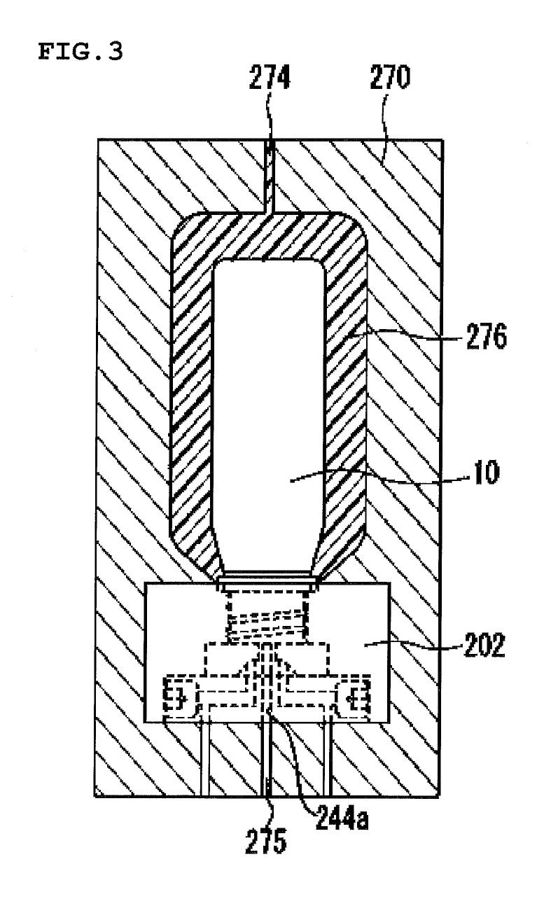

As shown in FIG. 3, a resin inflow path 274 for supplying the molten resin 276 is provided to communicate with the outside in an upper part of the cavity 273 of the mold 270. In this state, the molten resin 276 is charged into the cavity 273 between the outside of the main body portion 12 and the mold 270 through the resin inflow path 274 (overmolding process).

The second resin material (molten resin 276) is, for example, a polyester-based resin. The resin material (molten resin 276) of the resin sheathing body 30 is preferably a material having a higher solidification rate than the polyolefin-based resin material (first resin material) of the hollow molded body 10. The method of contrasting the solidification rates of the first resin material and the second resin material is not particularly limited. Since a resin material having a high solidification point generally has a high solidification rate, the solidification rates of the first resin material and the second resin material may be contrasted on the basis of a difference in level between the solidification points. That is, the second resin material is preferably a material having a higher solidification point than the first resin material.

In the overmolding process, the molten resin 276 flowing into the cavity 273 is charged into the cavity 273 while the hollow molded body 10 is pressed in a gravity direction.

At this time, a fluid is supplied into the hollow molded body 10 through the pipe line 275 and the flow path 244a provided in the mouth part mold 202. The fluid is charged into the hollow molded body 10 from the mouth-neck portion 20 to apply an internal pressure greater than an ambient pressure. The fluid may be a gas or a liquid, and its material is not limited. The fluid is, for example, pressurized air. The ambient pressure is, for example, atmosphere pressure. In this manner, in the overmolding process, by pressurizing the inside of the hollow molded body 10, the hollow molded body 10 can be prevented from being melted and deformed by a mold pressure.

In addition, the molten resin 276 is charged according to the irregularities formed on the surface of the frost-treated portion 122 of the thermally-expanded hollow molded body 10. However, the molten resin 276 which is a kind of polyester has poor wettability with respect to the hollow molded body 10 made of polyolefin, and thus has difficulty in entering the fine irregularities of the frost-treated portion 122. Therefore, the inner surface of the molten resin 276 opposed to the frost-treated portion 122 is solidified and aggregates without having a shape which completely matches the surface of the frost-treated portion 122. Accordingly, smaller irregularities than those of the surface of the frost-treated portion 122 are formed.

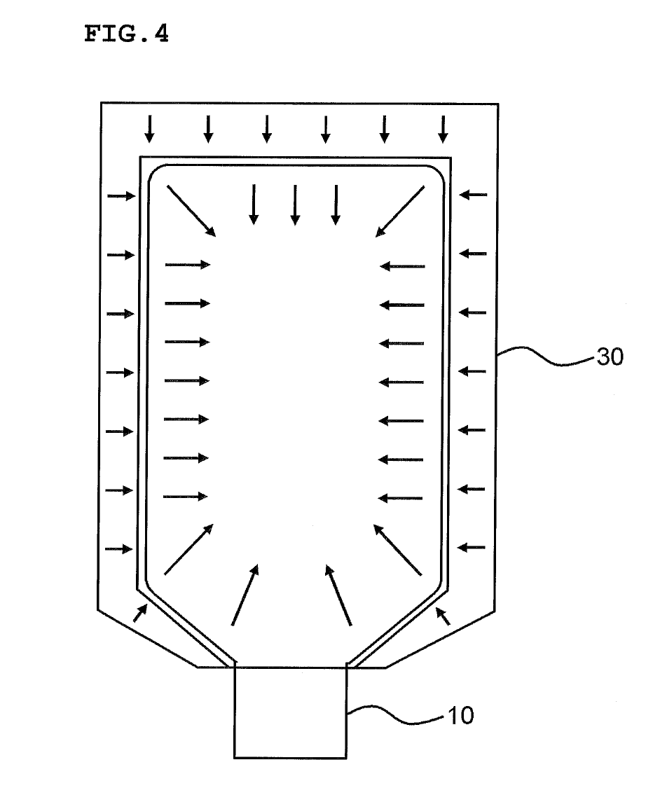

As shown in FIG. 4, the mold 270 is cooled so the temperature of it is lowered to be equal to or lower than the solidification point of the polyester, and thus the solidifying of the molten resin 276 to be the resin sheathing body 30 is started. The solidifying of the molten resin 276 mentioned here indicates that at least the inside of the molten resin 276 brought into contacts with the hollow molded body 10 is solidified. Accordingly, at this time, the whole molten resin 276 may be not solidified.

Thereafter, the hollow molded body 10 is thermally contracted. The “thereafter” mentioned here includes the case in which the hollow molded body 10 is thermally contracted simultaneously with the solidifying of the molten resin 276. In addition, the thermal contraction of the hollow molded body 10 may start from when the molten resin 276 is not yet solidified.

Generally, a polyester-based resin material has a higher solidification rate and a lower crystallization rate than a polyolefin-based resin material. As the second resin material (molten resin 276) of this embodiment, a material having a higher solidification point and a lower crystallization rate than the first resin material of the hollow molded body 10 can be selected. Accordingly, in the overmolding process, the resin sheathing body 30 is solidified earlier than the hollow molded body 10, but is difficult to crystallize or not crystallized, and thus a thickness dimension is not easily reduced. Meanwhile, the outer surface of the first resin material of the hollow molded body 10 warmed by the molten resin 276 during the overmolding is crystallized, and thus a thickness dimension is reduced. Therefore, a difference is generated in contraction time between the hollow molded body 10 and the resin sheathing body 30, and both of them are finely detached from each other. Thereafter, in a process of cooling the hollow molded body 10, since the resin sheathing body 30 is already solidified, the resin sheathing body 30 does not follow the thermal contraction of the hollow molded body 10. In this manner, due to differences in amount and time of the contraction deformation between the resin sheathing body 30 (molten resin 276) and the hollow molded body 10, the adhesion in the frost-treated portion 122 is lowered. Furthermore, a polyester resin has poor wettability with respect to polyolefin. These actions are synergistically exerted, and thus the molten resin 276 to be the resin sheathing body 30 and the hollow molded body 10 can be in an unfixed state.

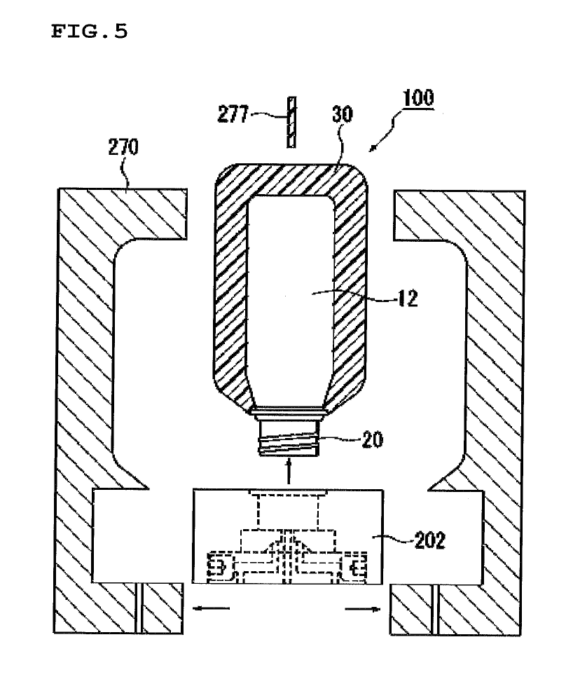

Next, as shown in FIG. 5, the molten resin 276 is solidified, and thus becomes the resin sheathing body 30. The mold 270 is removed and a runner 277 formed in the resin inflow path 274 is cut. In this manner, the resin container 100 according to the first embodiment is obtained.

In the resin container 100 overmolded in this manner, the resin sheathing body 30 is brought into sliding contact with the hollow molded body 10. The sliding contact indicates that one is slidably brought into contact with the other. In other words, when the main body portion 12 of the hollow molded body 10 is exposed by, for example, vertically cutting the resin sheathing body 30, it is possible to separate the hollow molded body 10 from the resin sheathing body 30 without substantially applying an external force. Specifically, it is preferable that the hollow molded body 10 be separable from the resin sheathing body 30 due to the weight of the hollow molded body 10.

According to the first embodiment, the main body portion 12 of the hollow molded body 10 is buried in the resin sheathing body 30 in an unfixed manner. Accordingly, the resin sheathing body 30 can be separated from the hollow molded body 10 without any force applied. Furthermore, since the resin sheathing body 30 is made of polyester, it can be recycled after separation. As described above, it is possible to provide the resin container 100 which can be recycled after separation.

### Second Embodiment

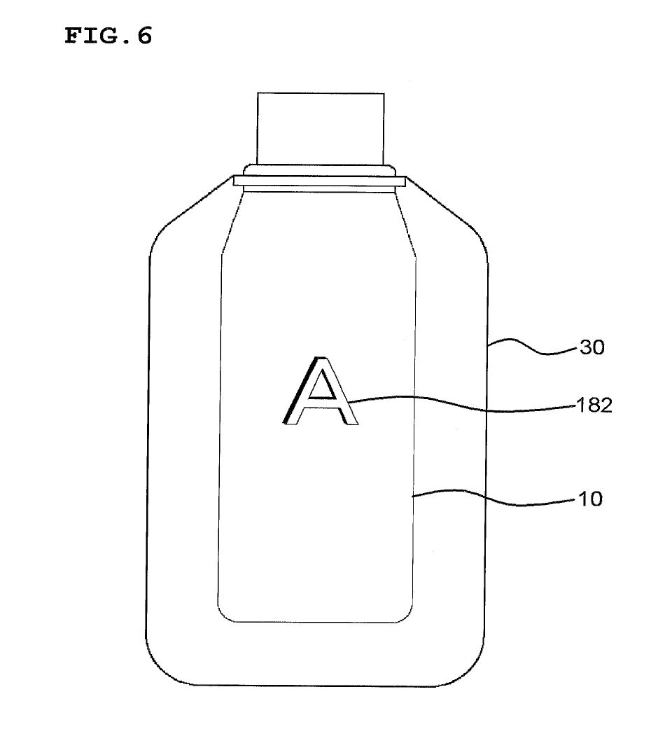

FIG. 6 is a cross-sectional view showing a configuration of a resin container 100 according to a second embodiment. The second embodiment is the same as the first embodiment, except that a letter or a figure is printed, engraved, or imprinted on a surface of a frost-treated portion 122 between a main body portion 12 and a resin sheathing body 30. Hereinafter, the detailed description will be given.

As shown in FIG. 6, in the resin container 100 according to the second embodiment, a letter or a figure is printed, engraved, or imprinted on the surface of the frost-treated portion 122 between the main body portion 12 and the resin sheathing body 30. For example, “A” which is an imprinted letter 182 is formed on the surface of the frost-treated portion 122. The imprinted letter 182 is formed on the surface of the frost-treated portion 122, but the position thereof is not limited.

In addition, a method of manufacturing the resin container 100 according to the second embodiment is the same as in the first embodiment, except that an overmolding process is performed in a state in which a letter or a figure is printed, engraved, or imprinted on the surface of the frost-treated portion 122.

A letter or a figure is printed, engraved, or imprinted on the surface of the frost-treated portion 122 in advance before the overmolding process. Next, the overmolding process is performed in a state in which the above-described processing has been conducted. Accordingly, in the overmolding process, irregularities corresponding to this letter or figure are formed in the molten resin 276. Since the frost treatment is performed, processing such as printing can be relatively easily performed even in the case of polyolefin which has difficulty in being subjected to processing such as printing.

According to the second embodiment, it is possible to obtain the same effect as in the first embodiment. Furthermore, a letter or a figure can be printed, engraved, or imprinted on the surface of the frost-treated portion 122. Accordingly, even when the transparent resin sheathing body 30 is interposed, visibility can be increased due to a letter or a figure provided on the surface of the frost-treated portion 122.

The total light transmittance of the resin material of the resin sheathing body 30 can be adjusted to equal to or greater than 80%. Accordingly, a visual effect such as a hologram is exhibited, such that a print or the like on the surface of the hollow molded body 10 clearly stand outs through the resin sheathing body 30. The thickness of the resin sheathing body 30 is not particularly limited, but can be adjusted to equal to or greater than 1 mm and equal to or smaller than 10 mm. Accordingly, the above-described visual effect such as a hologram is remarkably exhibited.

When the frost-treated portion 122 is formed simultaneously with the injection molding of the resin sheathing body 30, the letter or the figure may disappear by the injection molding, or molding into a desired shape may not be possible. In consideration of this point, according to the second embodiment, printing, engraving, or imprinting is conducted in advance before the overmolding process. Accordingly, the letter or the figure does not disappear even in the frost-treated portion 122. In addition, since the frost treatment is performed, processing such as printing can be relatively easily performed even in the case of polyolefin which has difficulty in being subjected to processing such as printing.

### Third Embodiment

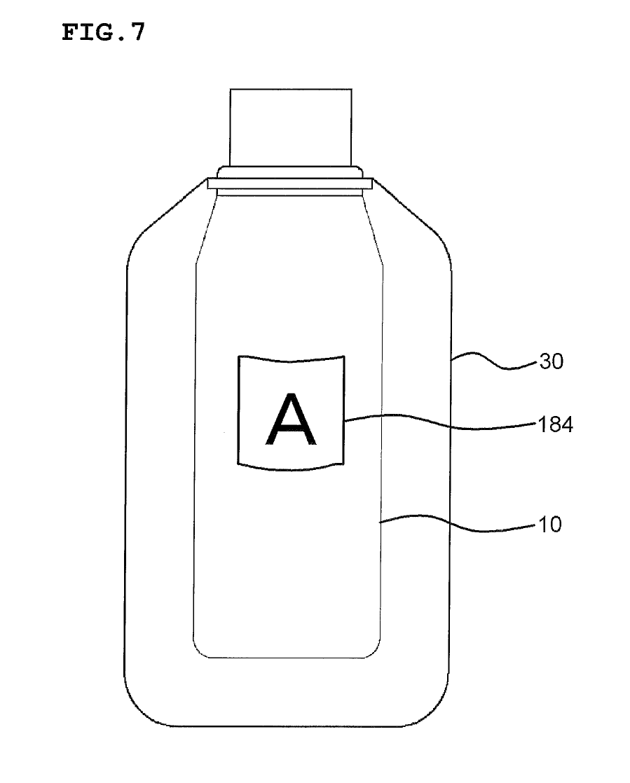

FIG. 7 is a cross-sectional view showing a configuration of a resin container 100 according to a third embodiment. The third embodiment is the same as the first embodiment, except that a film or a cloth is provided between a main body portion 12 and a resin sheathing body 30. Hereinafter, detailed description will be given.

As shown in FIG. 7, in the resin container 100 according to the third embodiment, a film or a cloth is provided between the main body portion 12 of a hollow molded body 10 and the resin sheathing body 30. For example, a film 184 is provided in a region including at least a part of a frost-treated portion 122 between the main body portion 12 and the resin sheathing body 30. The whole part of the film 184 is preferably brought into contact with the frost-treated portion 122.

Since the film 184 is heated by a molten resin 276 in an overmolding process, the film 184 preferably has heat resistance at approximately the temperature of the molten resin 276. Specifically, the melting point of the film 184 is preferably, for example, equal to or more than 200° C.

A letter or a figure is printed on the film 184. For example, a letter “A” is printed on a surface of the film 184.

An adhesive is applied to a side on which the film 184 is to be attached to the main body portion 12. Accordingly, the film 184 can be easily adhered to a surface of the hollow molded body 10.

A method of manufacturing the resin container 100 according to the third embodiment is the same as in the first embodiment, except that the overmolding process is performed in a state in which a film or a cloth is attached to a surface of the main body portion 12.

Before the overmolding process, the film 184 is attached in advance to a region including at least a part of the frost-treated portion 122 on the surface of the main body portion 12. Accordingly, in the overmolding process, irregularities corresponding to the shape of this film 184 are formed in the molten resin 276.

According to the third embodiment, it is possible to obtain the same effect as in the first embodiment. Furthermore, a film or a cloth can be provided between the main body portion 12 of the hollow molded body 10 and the resin sheathing body 30. Accordingly, since the resin sheathing body 30 is transparent, the film or the cloth can be favorably visually confirmed. When a letter or a figure is printed on the film or the cloth, good appearance can be easily made.

The film 184 is provided in a region including at least a part of the frost-treated portion 122 between the main body portion 12 and the resin sheathing body 30. Accordingly, a film or a cloth can be easily detached from the hollow molded body 10 upon recycling.

As described above, the embodiments of the invention have been described with reference to the drawings. However, these are only examples of the invention, and various configurations other than the above-described configurations can also be employed.

The above-described embodiments include the following technical thoughts.

(1) A resin container including: a hollow molded body which is made of polyolefin and has a tubular main body portion with a bottom and a mouth-neck portion, and in which a frost-treated portion subjected to a frost treatment is formed on a surface of the main body portion; and a resin sheathing body which is made of polyester and in which the main body portion is buried in an unfixed manner.

(2) The resin container according to (1), in which a gap is formed between the frost-treated surface and the resin sheathing body.

(3) The resin container according to (2), in which both surfaces which are opposed to each other with the gap interposed therebetween have irregularities corresponding to each other.

(4) The resin container according to any one of (1) to (3), in which the inner surface of the resin sheathing body opposed to the frost-treated portion has smaller irregularities than those of a surface of the frost-treated portion.

(5) The resin container according to any one of (1) to (4), in which in the hollow molded body, a surface of a shoulder portion from the mouth-neck portion to the main body portion is subjected to the frost treatment.

(6) The resin container according to any one of (1) to (5), in which the polyolefin is polypropylene or polyethylene.

(7) The resin container according to any one of (1) to (6), in which the polyester is polyethylene terephthalate or polybutylene terephthalate.

(8) The resin container according to any one of (1) to (7), in which a surface roughness Ra of the surface of the frost-treated portion is equal to or greater than 0.4 μm and equal to or smaller than 1.2 μm.

(9) The resin container according to any one of (1) to (8), in which a letter or a figure is printed, engraved, or imprinted on the surface of the frost-treated portion between the main body portion and the resin sheathing body.

(10) The resin container according to any one of (1) to (9), in which a film or a cloth is provided between the main body portion and the resin sheathing body.

(11) The resin container according to any one of (1) to (10), in which the resin sheathing body can be separated from the hollow molded body without any force applied.

(12) A resin container manufacturing method including: holding a mouth-neck portion of a hollow molded body to a mold by engaging the mouth-neck portion with the mold, wherein the hollow molded body is made of polyolefin and has a tubular main body portion with a bottom and the mouth-neck portion, and in which a frost-treated portion subjected to a frost treatment is formed on a surface of the main body portion, and an overmolding step of molding a resin sheathing body by applying an internal pressure greater than an ambient pressure to the hollow molded body by charging a fluid into the hollow molded body from the mouth-neck portion, and by charging molten polyester between the outside of the main body portion and the mold, in which in the overmolding step, the resin sheathing body and the main body portion are in an unfixed state due to thermal contraction of the hollow molded body.

(13) The resin container manufacturing method according to (12), in which the hollow molded body is thermally contracted after the resin sheathing body has a temperature equal to or lower than a melting point of the polyester.

(14) The resin container manufacturing method according to (12) or (13), in which the overmolding step is performed in a state in which a letter or a figure is printed, engraved, or imprinted on a surface of the frost-treated portion.

(15) The resin container manufacturing method according to (12) or (13), in which the overmolding step is performed in a state in which a film or a cloth is attached to a surface of the main body portion.

Priority is claimed on Japanese Patent Application No. 2011-037635, filed Feb. 23, 2011, the content of which is incorporated herein by reference.

1. A resin container comprising:
a hollow molded body which has a mouth-neck portion and a tubular main body portion with a bottom and is made of a first resin material; and
a resin sheathing body which is made of a second resin material and in which the main body portion is buried in an unfixed manner,
wherein a frost-treated portion subjected to a frost treatment is formed on at least a part of the main body portion.

2. The resin container according to claim 1,
wherein a gap is formed between the frost-treated portion and the resin sheathing body.

3. The resin container according to claim 2,
wherein a surface of the frost-treated portion and an inner surface of the resin sheathing body, which are opposed to each other with the gap interposed therebetween, have irregularities respectively, and the irregularities is formed in mutually corresponding form.

4. The resin container according to claim 3,
wherein the irregularities formed on the inner surface of the resin sheathing body are smaller than those formed on the surface of the frost-treated portion.

5. The resin container according to claim 1,
wherein the hollow molded body has a shoulder portion, the diameter of which is increased from the mouth-neck portion to the main body portion, and
the frost-treated portion is formed on a surface of the shoulder portion.

6. The resin container according to claim 1,
wherein the first resin material is a polyolefin-based resin.

7. The resin container according to claim 6,
wherein the polyolefin-based resin is polypropylene or polyethylene.

8. The resin container according to claim 1,
wherein a solidification rate of the second resin material is higher than a solidification rate of the first resin material.

9. The resin container according to claim 8,
wherein the second resin material is a polyester-based resin.

10. The resin container according to claim 9,
wherein the polyester-based resin is polyethylene terephthalate, amorphous polyethylene terephthalate, or a copolymer of polycyclohexane dimethyl terephthalate and polycyclohexane dimethylene isophthalate.

11. The resin container according to claim 1,
wherein a surface roughness Ra of the surface of the frost-treated portion is equal to or greater than 0.4 μm and equal to or smaller than 1.2 μm.

12. The resin container according to claim 1,
wherein a letter or a figure is printed, engraved, or imprinted on the surface of the frost-treated portion.

13. The resin container according to claim 1,
wherein a film or a cloth is provided between the main body portion and the resin sheathing body.

14. The resin container according to claim 1,
wherein the resin sheathing body is brought into sliding contact with the hollow molded body.

15. The resin container according to claim 1, which is a cosmetic container which is used to contain a cosmetic product in the hollow molded body.

16. A resin container manufacturing method comprising:
holding a mouth-neck portion of a hollow molded body to a mold by engaging the mouth-neck portion with the mold, wherein the hollow molded body is made of a first resin material and has the mouth-neck portion and a tubular main body portion with a bottom, and in which a frost-treated portion subjected to a frost treatment is formed on at least a part of the main body portion; and
an overmolding step of molding a resin sheathing body by applying an internal pressure greater than an ambient pressure to a hollow portion of the hollow molded body by charging a fluid into the hollow portion from the mouth-neck portion, and by charging a molten resin formed of a second resin material between the outside of the main body portion and the mold,
wherein in the overmolding step, the resin sheathing body and the main body portion are in an unfixed state due to thermal contraction of the hollow molded body.

17. The resin container manufacturing method according to claim 16,
wherein the hollow molded body is thermally contracted after the molded resin sheathing body has a temperature equal to or lower than a solidification point of the second resin material.

18. The resin container manufacturing method according to claim 16,
wherein the overmolding step is performed in a state in which a letter or a figure is printed, engraved, or imprinted on a surface of the frost-treated portion.

19. The resin container manufacturing method according to claim 16, wherein the overmolding step is performed in a state in which a film or a cloth is attached to a surface of the main body portion.
